(19) United States
(12) Patent Application Publication
(10) Pub. No.: US 2015/0215610 A1
(43) Pub. Date: Jul. 30, 2015

(54) STEREOSCOPIC PICTURES GENERATION

(71) Applicant: Essilor International (Compagnie Générale d'Optique), Charenton-le-Pont (FR)

(72) Inventor: Denis Rousseau, Charenton-le-Pont (FR)

(21) Appl. No.: 14/414,352

(22) PCT Filed: Jul. 9, 2013
(86) PCT No.: PCT/EP2013/064505

§ 371 Date: Jan. 12, 2015

(30) Foreign Application Priority Data
Jul. 12, 2012 (EP) 12305843.0

(51) Int. Cl. H04N 13/04; H04N 13/02; H04N 13/00

(52) U.S. Cl. CPC H04N 13/047; H04N 13/0022; H04N 13/0472; H04N 13/0239; H04N 13/0402; H04N 13/0429

(57) ABSTRACT

A stereoscopic pictures generating method comprising:—a providing step comprising:—a first providing operation during which at least one first user related parameter is provided, and—a second providing operation during which at least one second user related parameter is provided,—a determining step comprising:—a first determining operation during which a first picture parameter is determined based on the first user related parameter, the first picture parameter comprising a first distance to be set between two cameras embedded in a screen facing the second user, and—a second determining operation during which a second picture parameter is determined based on the second user related parameter, the second picture parameter comprising a second distance to be set between two cameras embedded in a screen facing the first user, and—a generating step comprising:—a first generating operation during which right and left stereoscopic pictures are generated based on the first picture parameter, the right and left stereoscopic pictures being to be displayed on the screen facing the first user, and a second generating operation during which right and left stereoscopic pictures are generated based on the second picture parameter, the right and left stereoscopic pictures being to be displayed on the screen facing the second user.

### CROSS REFERENCE TO RELATED APPLICATIONS

This application is a U.S. national stage application of International Application No. PCT/EP2013/064505 filed Jul. 9, 2013, which claims the benefit of priority to EP Application No. 12305843.0, filed Jul. 12, 2012; the entirety of each of said applications is incorporated herein by reference.

### FIELD OF THE INVENTION

The invention described herein relates to a generation of stereoscopic pictures.

### BACKGROUND

The discussion of the background herein is included to explain the context of the invention. This is not to be taken as an admission that any of the material referred to was published, known or part of the common general knowledge at the priority date of any of the claims.

Stereoscopic pictures generating system may present the drawback of not being optimized for the user of said system.

Consequently, it can quickly give rise to the user suffering dizziness and nausea.

### SUMMARY

One object described herein is to provide the stereoscopic pictures generating system and method described herein that do not present the drawbacks mentioned hereinabove.

Another object of the invention is to provide the stereoscopic pictures generating system and method described herein that enhance the realistic effect of 3D display.

In particular, one object of the invention is to provide the stereoscopic pictures generating system and method described herein enabling 3D information content to be viewed while limiting visual fatigue and discomfort for the user of said system.

To this end, described herein is a stereoscopic pictures generating method comprising:

a providing step comprising:

a first providing operation during which at least one first user related parameter is provided, and

a second providing operation during which at least one second user related parameter is provided,

a determining step comprising:

a first determining operation during which a first picture parameter is determined based on the first user related parameter, the first picture parameter comprising a first distance to be set between two cameras embedded in a screen facing the second user, and

a second determining operation during which a second picture parameter is determined based on the second user related parameter, the second picture parameter comprising a second distance to be set between two cameras embedded in a screen facing the first user, and

a generating step comprising:

a first generating operation during which right and left stereoscopic pictures are generated based on the first picture parameter, the right and left stereoscopic pictures to be displayed on the screen facing the first user, and

a second generating operation during which right and left stereoscopic pictures are generated based on the second picture parameter, the right and left stereoscopic pictures to be displayed on the screen facing the second user.

Thus, right and left stereoscopic pictures are generated based on at least one user related parameter so that said user views the information content under conditions that are best adapted to the user's physiology. Consequently, the physiological fatigue is minimized.

Unless specifically stated otherwise, as apparent from the following discussions, it is appreciated that throughout the specification discussions utilizing terms such as “computing”, “calculating”, “generating”, or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

Embodiments described herein may include apparatuses for performing the operations herein. This apparatus may be specially constructed for the desired purposes, or it may comprise a general purpose computer or Digital Signal Processor (“DSP”) selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments presented herein are not described with reference to any particular programming language. It will be appreciated that a variety of programming languages may be used to implement the teachings as described herein.

### BRIEF DESCRIPTION OF THE DRAWINGS

Non limiting embodiments will now be described with reference to the accompanying drawings, wherein:

FIG. 1 is a schematic block diagram representing a user, a binocular viewing device, a screen, and a stereoscopic pictures generating system according to some embodiments described herein;

FIG. 2 is a flow chart showing steps of a stereoscopic pictures generating method according to some embodiments described herein; and

FIG. 3 is a schematic block diagram showing two users handling a videoconference using two stereoscopic pictures generating systems.

### DESCRIPTION

Elements in the figures are illustrated for simplicity and clarity and have not necessarily been drawn to scale. For example, the dimensions of some of the elements in the figures may be exaggerated relative to other elements to help improve the understanding of the embodiments described herein.

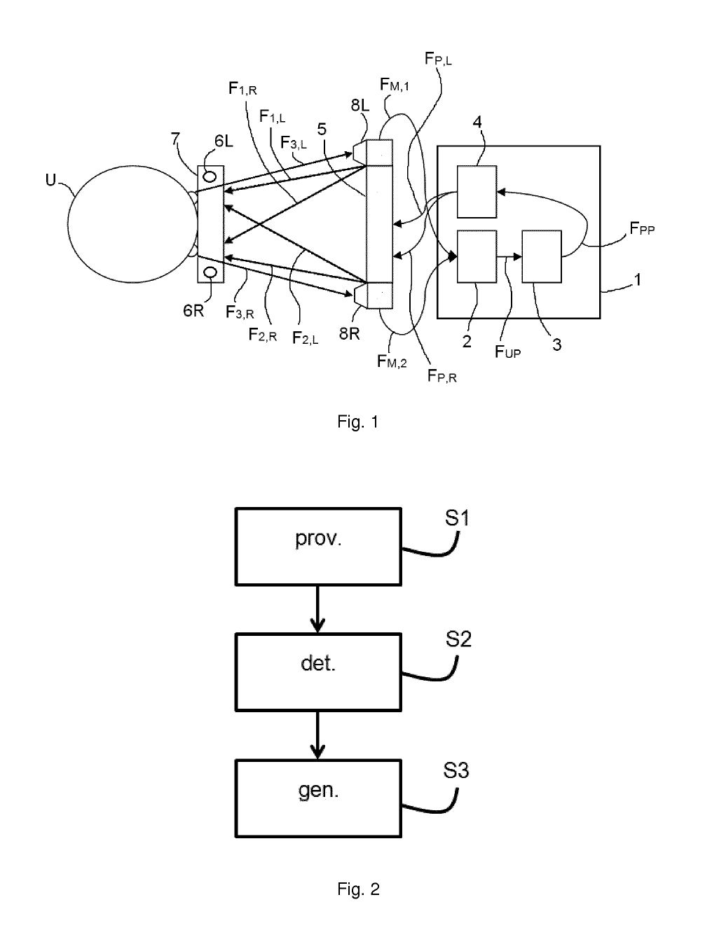

FIG. 1 shows a user U, a binocular viewing device 7, a screen 5, and a stereoscopic pictures generating system 1 according to some embodiments.

The screen 5 is designed to perform stereoscopic display, for example, active stereoscopic display (shutter), passive stereoscopic display (polarization), autostereoscopic display, or other display.

The system 1 comprises providing means 2 configured to provide at least one user related parameter.

For instance, the at least one user related parameter may comprise the interpupillary distance of the user U in close vision, in intermediary vision, or in far vision. The interpupillary distance is defined in the standard ISO 13666:1998.

According to some embodiments, the providing means 2 are configured to obtain the at least one user related parameter from a measurement.

The measurement may be performed by using right and left cameras 6_{L} and 6_{R} embedded in the binocular viewing device 7, which is designed to be worn by the user U. This measurement may thus be performed without the use of cameras embedded in the screen 5. The measurement is then transmitted from the binocular viewing device 7 to the providing means 2 by means of any type of connection, for example, a wireless connection.

Alternatively, the measurement may be performed by using a camera 8_{L} or 8_{R} embedded in the screen 5 and two benchmarks provided on the binocular viewing device 7. Arrows F_{1,L} and F_{1,R} are used to sympolize such a measurement performed by camera 8_{L}. Similarly, arrows F_{2,L} and F_{2,R} are used to sympolize such a measurement performed by camera 8_{R}. This measurement may be performed with the use of a single camera embedded in the screen 5. The measurement is then transmitted from the screen 5 to the stereoscopic pictures generating system 1 by means of any type of connection, for example, a wireless connection, as symbolized by arrows F_{M,1} and F_{M,2}.

Alternatively, the measurement may be performed by using two camera 8_{L} and 8_{R} embedded in the screen 5, as symbolized by arrows F_{3,L} and F_{3,R}. This measurement may be performed without the use of a binocular viewing device 7. The measurement is then transmitted from the screen 5 to the stereoscopic pictures generating system 1 by means of any type of connection, for example, a wireless connection, as symbolized by arrows F_{M,1} and F_{M,2}.

The at least one user related parameter may further or instead comprise the distance between the user U and the screen 5 facing the user U, that is to say the image display distance. Such a measurement may be performed by using one or two camera(s) 8_{L}, 8_{R} embedded in the screen 5.

The measurement may be performed periodically, for instance, during right and left videos generation. It is thus possible to obtain a current position of the user U, for instance, when the user U is playing a video game.

According to other embodiments, the providing means 2 are configured to obtain the at least one user related parameter from a device storing the user related parameter. The device storing the user related parameter may be embedded in the system 1 or may be a remote device configured to communicate with the system 1.

The system 1 further comprises determining means 3 configured to receive the at least one user related parameter, as symbolized by arrow F_{UP}, and to determine a pictures parameter based on the at least one user related parameter.

For instance, when two cameras 8_{L}, 8_{R} are embedded in the screen 5, the determining means 3 may be configured to determine a distance to be set between the two cameras 8_{L}, 8_{R}.

The determining means 3 may further or instead be configured to determine a display positioning of a right picture on the screen 5 and a display positioning of a left picture on the screen 5.

The system 1 further comprises generating means 4 configured to receive the pictures parameter, as symbolized by arrow F_{PP}, and to generate right and left stereoscopic pictures based on the pictures parameter.

For instance, when the generating means 4 are configured to generate the right and left pictures based on a determined right and left display positioning, the right and left pictures may be generated by setting picture margins based on the determined right and left display positioning.

When the generating means 4 are configured to generate the right and left pictures based on a distance to be set between the two cameras 8_{L}, 8_{R}, the generating means 4 may transmit a command signal to the screen 5 to set the positions of the two cameras 8_{L}, 8_{R}.

Then, the generated right and left stereoscopic pictures are displayed on a screen.

In some embodiments, the screen displaying the right and left pictures is the screen 5 facing the user U associated with the user related parameter. In these embodiments, the generated pictures are transmitted from the generating means 4 to the screen 5, as symbolized by arrows F_{P,L} and F_{P,R}. The display may thus be set as a function of the morphology of the user U, for example, when the user U is playing a video game or watching a movie.

According to other embodiments, the screen displaying the right and left pictures is a second screen facing a second user. The pictures generation may thus be adapted as a function of a second user, for example, when the user U and the second user are handling a videoconference.

According to an embodiment illustrated on FIG. 2, the stereoscopic pictures generating method according to the invention comprises:

a providing step S1,

a determining step S2, and

a generating step S3.

The stereoscopic pictures generating method may be implemented by the stereoscopic pictures generating system 1 disclosed above.

During the providing step Si at least one user related parameter is provided.

The providing step Si may comprise a measurement operation during which the user related parameter is measured, or may comprise an obtaining operation during which the at least one user related parameter is obtained from a device storing the user related parameter.

For instance, the user related parameter is measured during a first implementation of the method and then is stored to be reused.

During the determining step S2, a pictures parameter is determined based on the at least one user related parameter provided in step S1.

The pictures parameter may comprise, for instance, a distance to be set between two cameras 8_{L} and 8_{R} embedded in the screen 5, and/or a display positioning of the right picture on the screen 5 and a display positioning of the left picture on the screen 5.

During the generating step S3 right and left stereoscopic pictures are generated based on the pictures parameter.

Then, the right and left stereoscopic pictures are transmitted to a screen to be displayed.

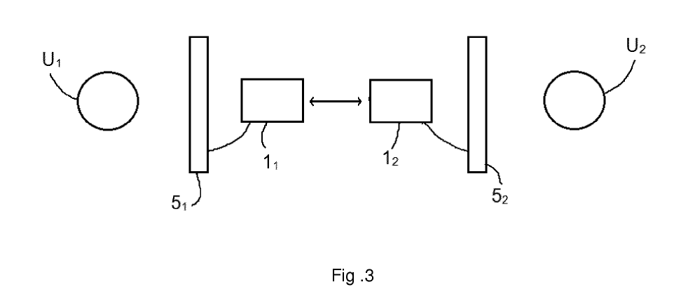

FIG. 3 represents an example embodiment, in which a first user U₁ and a second user U₂ are handling a videoconference.

The first user U₁ is facing a first screen 5₁ and the second user U₂ is facing a second screen 5₂. A first stereoscopic pictures generating system 1₁ is connected to the first screen 5₁. A second stereoscopic pictures generating system 1₂ is connected to the second screen 5₂. The connections may be wireless connections. The first stereoscopic pictures generating system 1₁ and the second stereoscopic pictures generating system 1₂ are configured to communicate with one another, for instance, by using the Internet.

The right and left videos showing the first user U₁, referred to as first right and left videos, are provided from right and left cameras embedded in the first screen 5₁. The right and left videos showing the second user U₂, referred to as second right and left videos, are provided from right and left cameras embedded in the second screen 5₂. The first right and left videos are thus displayed on the second screen 5₂ while the second right and left videos are displayed and the first screen 5₁.

In this example embodiment, the providing step S1 comprises a first providing operation during which at least one first user U₁ related parameter is provided. The first user related parameter comprises the interpupillary distance of the first user U₁ in close vision, in intermediary vision, or in far vision. The first providing operation may be performed by the providing means of the first stereoscopic pictures generating system 1₁.

Moreover, the providing step S1 comprises a second providing operation during which at least one second user U₂ related parameter is provided. The second user related parameter comprises the interpupillary distance of the second user U₂ in close vision, in intermediary vision, or in far vision. The second providing operation may be performed by the providing means of the second stereoscopic pictures generating system 1₂.

The determining step S2 comprises a first determining operation during which a first pictures parameter is determined based on the first user related parameter. The first picture parameter comprises a first distance to be set between the two cameras embedded in the second screen 5₂. The first determining operation may be performed by the determining means of the first stereoscopic pictures generating system 1₁. In that case the first pictures parameter is then transmitted to the second stereoscopic pictures generating system 1₂. Alternatively, the first user related parameter may be transmitted to the second stereoscopic pictures generating system 1₂ and the first determining operation may be performed by the determining means of the second stereoscopic pictures generating system 1₂.

Moreover, the determining step S2 comprises a second determining operation during which a second pictures parameter is determined based on the second user related parameter. The second picture parameter comprises a second distance to be set between the two cameras embedded in the first screen 5₁. The second determining operation may be performed by the determining means of the second stereoscopic pictures generating system 1₂. In that case the second pictures parameter is then transmitted to the first stereoscopic pictures generating system 1₁. Alternatively, the second user related parameter may be transmitted to the first stereoscopic pictures generating system 1₁ and the second determining operation may be performed by the determining means of the first stereoscopic pictures generating system 1₁.

The generating step S3 comprises a first generating operation during which first right and left stereoscopic pictures are generated. The first right and left pictures are provided from the two cameras embedded in the first screen 5₁, the distance between the two cameras being set according to the second pictures parameter. The first generating operation may be performed by the generating means of the first stereoscopic pictures generating system 1₁. The first right and left pictures are then transmitted to the second screen 5₂, and displayed on the second screen 5₂. As the distance between the two cameras embedded in the first screen 5₁ has been set as a function of the interpupillary distance of the second user U₂, the first right and left pictures are specifically adapted to the second user.

Moreover, the generating step S3 comprises a second generating operation during which second right and left stereoscopic pictures are generated. The second right and left pictures are provided from the two cameras embedded in the second screen 5₂, the distance between the two cameras being set according to the first pictures parameter. The second generating operation may be performed by the generating means of the second stereoscopic pictures generating system 1₂. The second right and left pictures are then transmitted to the first screen 5₁, and displayed on the first screen 5₁. As the distance between the two cameras embedded in the second screen 5₂ has been set as a function of the interpupillary distance of the first user U₁, the first right and left pictures are specifically adapted to the first user.

The invention has been described above with the aid of embodiments without limitation of the general inventive concept.

1. A stereoscopic pictures generating method comprising:
a providing step comprising:
at least a first providing operation during which at least one first user related parameter is provided, and
at least a second providing operation during which at least one second user related parameter is provided;
a determining step comprising:
at least a first determining operation during which a first picture parameter is determined based on the at least one first user related parameter, the first picture parameter comprising a first distance to be set between two cameras embedded in a screen facing a second user, and
at least a second determining operation during which a second picture parameter is determined based on the at least one second user related parameter, the second picture parameter comprising a second distance to be set between two cameras embedded in a screen facing a first user; and
a generating step comprising:
at least a first generating operation during which right and left stereoscopic pictures are generated based on the first picture parameter, the right and left stereoscopic pictures being to be displayed on the screen facing the first user, and
at least a second generating operation during which right and left stereoscopic pictures are generated based on the second picture parameter, the right and left stereoscopic pictures to be displayed on the screen facing the second user.

2. The stereoscopic pictures generating method according to claim 1, wherein the at least one first and second user related parameters comprise interpupillary distance of a corresponding user in close vision, in intermediary vision, or in far vision.

3. The stereoscopic pictures generating method according to claim 1, wherein the at least one first and second user related parameters comprise a distance between a corresponding user and a screen.

4. The stereoscopic pictures generating method according to claim 1, wherein each screen is designed to display right and left videos, each video comprising a set of pictures, the providing step being repeated more than one time during display of at least one of the right and left videos.

5. The stereoscopic pictures generating method according to claim 1, wherein the providing step comprises an obtaining operation during which one or more user related parameters are obtained from a device storing the one or more user related parameters.

6. The stereoscopic pictures generating method according to claim 1, wherein the providing step comprises a measurement operation during which one or more user related parameters are measured.

7. The stereoscopic pictures generating method according to claim 6, wherein the measurement operation is performed by using right and left cameras embedded in at least one binocular viewing device designed to be worn by at least one user.

8. The stereoscopic pictures generating method according to claim 6, wherein the measurement operation is performed by using at least a camera embedded in at least one screen.

9. The stereoscopic pictures generating method according to claim 1, wherein at least one of the first picture parameter and the second picture parameter further comprises one or more of a display positioning of a right picture on a corresponding screen and a display positioning of a left picture on a corresponding screen.

10. A computer program product comprising a processor, a memory coupled to the processor, the memory comprising one or more stored sequences of computer program instructions that are accessible to and executable by the processor and which, when executed by the processor, causes the processor to carry out the method of claim 1.

11. A computer product embodied on a non-transitory computer readable medium including and carrying one or more stored sequences of computer program instructions of the computer program product of claim 10.

12. A stereoscopic pictures generating system comprising:
providing means configured to provide at least one first user related parameter;
determining means configured to determine a first picture parameter based on the at least one first user related parameter, the first picture parameter comprising a first distance to be set between two cameras embedded in a screen facing a second user; and
generating means configured to generate right and left stereoscopic pictures based on the first picture parameter, the right and left stereoscopic pictures to be displayed on a screen facing a first user.

13. The computer program product of claim 10, further comprising instructions for a providing step for providing at least one of a first or second user related parameter, instructions for a determining step for determining at least one of a first or second picture parameter based on the at least one of the first or second user related parameter, and instructions for a generating step for generating stereoscopic pictures on at least one screen based on at least one of the first or second picture parameter.

14. The stereoscopic pictures generating system of claim 12, wherein the providing means obtains the at least one first user related parameter from a measurement of at least one of interpupillary distance of the first user in close vision, interpupillary distance of the first user in intermediary vision, and interpupillary distance of the first user in far vision.

15. The stereoscopic pictures generating system of claim 12, wherein the providing means includes at least one of a right camera and a left camera, such that at least of the right camera and the left camera are provided in a viewing device.

16. The stereoscopic pictures generating system of claim 12, wherein the providing means includes at least one of a right camera and a left camera, such that at least of the right camera and the left camera are embedded in at least one of the screen facing the first user and the screen facing the second user.

17. The stereoscopic pictures generating system of claim 12, wherein the determining means receives the at least one first user related parameter and obtains the first picture parameter based at least in part on one or more of the first distance, and a display positioning of a picture provided on the screen facing the first user.

18. The stereoscopic pictures generating system of claim 12, wherein the generating means transmits instructions to set positions of the two cameras.

19. The stereoscopic pictures generating system of claim 12, wherein the generating means sets picture margins for the right and left stereoscopic pictures.

20. The stereoscopic pictures generating system of claim 12, wherein the stereoscopic pictures generating system includes a first stereoscopic pictures generating system in operable communication with a first screen and a second stereoscopic pictures generating system in operable communication with a second screen, the first and second stereoscopic pictures generating system further configured to communication with each other.
